(19) United States
(12) Patent Application Publication
(10) Pub. No.: US 2021/0344820 A1
(43) Pub. Date: Nov. 4, 2021

(54) SYSTEM AND METHOD FOR POSITIONING OF A VISUAL PRODUCTION LINE INSPECTION APPLIANCE

(71) Applicant: INSPEKTO A.M.V. LTD., RAMAT GAN (IL)

(72) Inventors: HAREL BOREN, GIVAT SHMUEL (IL); ASHER ELBAZ, NAALE (IL); MICHAEL GOTLIEB, RAANANA (IL); YONATAN HYATT, TEL-AVIV (IL)

(21) Appl. No.: 17/266,641

(22) PCT Filed: Aug. 8, 2019
(86) PCT No.: PCT/IL2019/050904

§ 371 Date: Feb. 8, 2021

Related U.S. Application Data
(60) Provisional application No. 62/818,169, filed on Mar. 14, 2019.
(60) Provisional application No. 62/717,007, filed on Aug. 10, 2018.

(30) Foreign Application Priority Data
Aug. 10, 2018 (IL) 261097

(51) Int. Cl. H04N 5/225; H04N 5/232; H04N 5/247; G01N 21/88; F16M 11/26; F16M 11/20; F16M 11/38

(52) U.S. Cl. CPC H04N 5/2253; H04N 5/23299; H04N 5/2256; H04N 5/247; G01N 2021/0106; G01N 21/8803; F16M 11/26; F16M 11/2064; F16M 11/38; H04N 5/2328

(57) ABSTRACT

A kit, system and method for positioning a camera assembly for automated visual inspection of at least one item, are provided. Provided are a camera assembly and a mounting assembly adapted to support the camera assembly wherein the mounting assembly is adapted for assembly and installation by an untrained user and wherein the installation can be guided by a planner application running on a computing device; such that the FOV of the camera assembly includes the item to be inspected.

### FIELD

The present disclosure relates to visual inspection of items on a production line and more specifically to simplified installation and positioning of an inspection appliance.

### BACKGROUND

Inspection during production processes helps control the quality of products by identifying defects and then acting upon this detection, for example, by fixing the defect or discarding the defective part. The process of defect detection is essential for quality assurance (QA), gating, and sorting on production lines, and is consequently useful in improving productivity, improving production processes and working procedures, reducing defect rates, and reducing re-work and waste.

Automated visual inspection methods are used in production lines to identify visually detectable anomalies that may have a functional or aesthetic impact on a manufactured part. Due to the underlying technologies that drive them, current visual inspection solutions for production lines are: (1) typically highly customized to a particular product and the particular QA, gating, or sorting task that is addressed; (2) very expensive; (3) very time consuming to set up; (4) require expert selection and integration of hardware, cameras, lighting and software components; and (5) require expert maintenance of these throughout the lifetime of the inspection solution and the production line. The planning, design, installation, customization and maintenance are generally performed by a system integrator—which may be an external or internal entity.

The highly time-consuming aspects of setting up a QA, gating or sorting apparatus include: (1) meticulous planning, selection, and thereafter positioning of the inspection camera such that its field of view includes the item or area for inspection; (2) meticulous planning, installing and testing of the items or area for inspection such that objects are presented to the inspection camera in a repetitive manner; and (3) careful planning and positioning of the light source, or sources, so as to adequately light the item or area for inspection, in a way best serving the particular case and preventing any unwanted reflections. Further, components such as cameras and lighting require still further fine-positioning as their positions affect one another.

Still further, mounting systems for both camera and lighting, as well as holding or transport mechanisms for the object being inspected, are generally tailor-made for the specific situation and tightly fixed in position as slight changes may render the system unusable. These mounting systems are thus provided and assembled by the system integrator and generally cannot be repurposed for different inspection systems or different positions. Finally, the mounting system will typically be positioned on a separate fixed surface that is not a part of the production line itself so that the camera is not affected by vibrations or movement from the production line which could disrupt the image capture.

It is therefore not feasible for a customer of such a system to install the camera and lighting without significant involvement of the system supplier, resulting in additional expense and total reliance on the system supplier. Further, repurposing a current visual inspection solution, such as where production lines change, or the visual inspection system is required elsewhere in the manufacturing plant, or in another plant altogether, can only be done by the supplier and will generally require new custom made mounting hardware, lighting, positioning, and so forth as required in the setup of the original system.

As a result of the intensive costs, human resources, and sheer time requirements, that are associated with tailoring inspection solutions as described above, manufacturing plants are able to deploy only a limited number of such systems. In addition, manufacturing plants must supplement these efforts with an expensive internal/external human workforce to perform quality assurance (QA), gating, sorting or other tasks, instead of utilizing staff to augment productivity, quality, and safety, or improving capital efficiency and pricing for end-customers. Alternatively the plant is left with no other option but to skip inspection of items and run the risk of decreased quality resulting in potential loss of reputation and even financial claims against the plant for inferior products.

### SUMMARY

The present disclosure overcomes the drawbacks of the prior art by providing an automated visual inspection appliance (VIA) for a production line that can be easily and quickly installed for inspection without significant tailored integration. Fast and accurate installation of the inspection camera and lighting is enabled using a combination of an installation planner application, a customizable mounting assembly, and a combined camera/lighting assembly. The ease of setup is further enabled by a combination of machine learning, and computer vision algorithms that dynamically adapt to assess the item to be inspected, the target area of inspection, and the characteristics of the surrounding environment effecting the inspection setup.

In one embodiment, the system (VIA) is provided as an appliance comprising a customizable mounting assembly, and a camera assembly which comprises an inspection camera and light source, wherein the inspection camera and light source are both in communication with a controller. The controller can adjust camera parameters such as focus, zoom, white balance and others. The controller can further adjust the intensity and color of the light source or portions of the light source. An optional polarization filter covers the camera lens such that rotation of the filter can reduce or remove unwanted reflections. An optional diffuser spreads light from the light source evenly in the inspected area. These features and functions enable fast setup of the appliance as it can automatically adjust to any lighting environment or position without requiring extensive planning or integration.

The customizable mounting assembly can be assembled by a user of the VIA with no specialized training (or assistance from a system integrator) and can easily be repurposed (e.g., adjusted to suit a different inspection situation or moved to a different inspection position) as required by the production environment. In one embodiment, the mounting assembly comprises mounts and multiple adjustable segments joined together at rotating joints all of which may be marked with length and angle numbers. The mount can be attached to any profile (e.g., an aluminum profile) available on the production line or to any other surface.

In one embodiment, the mount and/or camera assembly are provided with stabilizers for vibration damping and an accelerometer for analysis of camera movement such that the appliance can be installed on surfaces that are part of the production line assembly without the production line movement disturbing the operation of the appliance.

Setup of the mounting assembly requires simply assembling the assembly and then adjusting the segments and joints to position the camera assembly for inspection of the item to be inspected. To further simplify installation, the controller comprises, inter alia, a planner application or software module that can be used to guide the assembly and installation of the mounting assembly. The planner application provides instructions for assembling and adjusting the mounting assembly such that the field of view of the camera assembly covers the items to be inspected, typically, in an optimal position for inspection. Therefore, the installation of the camera assembly of the automated visual inspection appliance disclosed herein is simple to perform and does not require specially trained staff.

In one embodiment, installation of the mounting assembly and camera assembly is performed as follows:

Measurements are made of the position of the item to be inspected relative to the mounting surface of the mounting assembly;

These measurements are input into the planner application;

Based on these measurements the planner application calculates the optimal position for the camera and lighting source and outputs instructions for assembly and adjustment of the mounting assembly that will result in positioning of the camera assembly in this optimal position; and

The mounting assembly is assembled and adjusted according to the provided instructions including attachment of the camera assembly.

Alternatively, the mounting assembly is assembled and the camera assembly is positioned manually and then fine-tuned by making manual adjustments to the position of the camera assembly till it is in the optimal position.

Alternatively, installation of the mounting assembly and camera assembly is performed as follows:

Measurements are made of the position of the item to be inspected relative to the mounting surface of the mounting assembly;

The mounting assembly is assembled using segments of appropriate length to position the camera assembly such that the FOV of the camera assembly covers the item to be inspected;

The camera assembly is attached to the mounting assembly and fine tuning of the mounting assembly positions the camera assembly correctly.

Alternatively, the mounting assembly is motorized and the planner application or controller (used interchangeably herein for this purpose) controls the motorized mounting assembly to move the camera assembly into the optimal position.

Once the mount and camera assemblies are installed, the VIA can be initiated. Optionally, in use, defect free embodiments of items to be inspected are first processed in a setup stage where the controller learns parameters of the items as captured in images by the camera assembly. In some embodiments no database of defects is used (such as used in most prior art systems), only defect-free items are analyzed during the setup stage. Once setup is completed, these parameters may be consolidated into a profile which may be stored on the controller, describing each item including positioning data for the mount. Multiple profiles describing multiple items may thus be created. In some embodiments, prior to inspection, the appropriate profile is selected for the item to be inspected. Items to be inspected preferably comprise any item type, shape or material, set in any lighting environment, without any limitation.

In the inspection stage, inspected items, (manufactured items that are to be inspected for defects or for gating or sorting or other inspection tasks), are imaged and the image data collected by the camera from each inspected item is processed by the controller. The controller may use machine learning algorithms which provide human-level analysis of defects in inspection images even with differing illumination conditions, different reflections, shading, varying location, shape tolerances, etc.

The terms “item” and “object” may be used interchangeably. As used herein the term “item” refers to a production item wherein production items may be different production stages of the same product or may be different products or different production stages of different products or the same item inspected from different angles. Items may be of any type, shape, size, material, or any other attribute and no example of an item herein should be considered limiting.

As used herein “untrained user” refers to an individual tasked with assembling the mounting assembly of the present disclosure (without the help of a systems integrator) who has not received prior training in assembly of the mounting assembly and who has never assembled the mounting assembly of the present disclosure.

As used herein, the term “defect” may include, for example, a visible flaw on the surface of an item, an undesirable size, shape or color of the item or of parts of the item, an undesirable number of parts of the item, a wrong or missing assembly of its interfaces, a broken or burned part, an incorrect alignment of an item or parts of an item, and in general, any difference between a defect free sample and the inspected item. Optionally or additionally a defect is a difference which would be evident to a human user between a defect free item (and/or group of defect free items) and a same-type inspected item.

The processes described below refer, for simplicity, to “images”, however it should be appreciated that the processes described herein may be carried out on image data other than or in addition to full images. The term “images” also includes video captured by the cameras of the presently described system.

While the description below assumes that the setup stages and inspection stages take place on the same inspection line, it should be noted that a profile (e.g., as described above) may include setup parameters (e.g., distance of the item from the camera and/or location of the item within the field of view) and the inspection may therefore take place, using the profile parameters, in a separate location with a separate VIA, or with the same VIA remounted in a different place and/or production line.

The term “product stage” as used herein should be understood to include any of an assembly stage (items are assembled into a product), manufacturing stage (items are subjected to a form of processing as part of product manufacture), and/or inspection stage (stages are actually different views or sections of the same product). As used herein product stages are related to one another by their being production stages or aspects of a product. The term item may be used to refer to a product stage. As used herein a “product” may refer to a completed commercial product but may also refer to a manufactured item or part that is destined for integration into a product.

Inspection of items as described herein should also be understood as inspection for purposes of defect detection, gating, counting, sorting and/or other inspection tasks. Where one of these terms is used e.g.: “defect detection”, this should be understood as referring to any inspection task, such as, defect detection, gating, counting, or sorting.

Unless otherwise defined, all technical and scientific terms used herein have the same meaning as commonly understood by one of ordinary skill in the art to which this disclosure belongs. The materials, methods, and examples provided herein are illustrative only and not intended to be limiting.

Implementation of the method and system of the present disclosure involves performing or completing certain selected tasks or steps manually, automatically, or a combination thereof. Moreover, according to actual instrumentation and equipment of preferred embodiments of the method and system of the present disclosure, several selected steps could be implemented by hardware or by software on any operating system of any firmware or a combination thereof. For example, as hardware, selected steps of the disclosure could be implemented as a chip or a circuit. As software, selected steps of the disclosure could be implemented as a plurality of software instructions being executed by a computer using any suitable operating system. In any case, selected steps of the method and system of the disclosure could be described as being performed by a data processor, such as a computing platform for executing a plurality of instructions.

Unless specifically stated otherwise, as apparent from the following discussions, it is appreciated that throughout the specification discussions utilizing terms such as “analyzing”, “processing,” “computing,” “calculating,” “determining,” “detecting”, “identifying” or the like, refer to the action and/or processes of a computer, or similar electronic computing device as defined below, that manipulates and/or transforms data represented as physical, such as electronic, quantities within the computing system's registers and/or memories into other data similarly represented as physical quantities within the computing system's memories, registers or other such information storage, transmission or display devices. Unless otherwise stated, these terms refer to automatic action of a processor, independent of and without any actions of a human operator.

As used herein the terms “machine learning” or “artificial intelligence” refer to use of algorithms on a computing device that parse data, learn from this data, and then make a determination, where the determination is not deterministically replicable (such as with deterministically oriented software as known in the art).

Although the present disclosure is described with regard to a “computing device”, a “computer”, or “mobile device”, it should be noted that optionally any device featuring a data processor and the ability to execute one or more instructions may be described as a computer, including but not limited to any type of personal computer (PC), a server, a distributed server, a virtual server, a cloud computing platform, a cellular telephone, an IP telephone, a smartphone, or a PDA (personal digital assistant). Any two or more of such devices in communication with each other may optionally comprise a “network” or a “computer network”.

### BRIEF DESCRIPTION OF THE DRAWINGS

The disclosure is herein described, by way of example only, with reference to the accompanying drawings. With specific reference now to the drawings in detail, it is stressed that the particulars shown are by way of example and for purposes of illustrative discussion of the preferred embodiments of the present disclosure only, and are presented in order to provide what is believed to be the most useful and readily understood description of the principles and conceptual aspects of the disclosure. In this regard, no attempt is made to show structural details of the disclosure in more detail than is necessary for a fundamental understanding of the disclosure, the description taken with the drawings making apparent to those skilled in the art how the several forms of the disclosure may be embodied in practice. The disclosure will now be described in relation to certain examples and embodiments with reference to the following illustrative figures so that it may be more fully understood. In the drawings:

FIGS. 1A-1G and 1H are respectively illustrative schematic drawings and a flow diagram showing installation of an automated visual inspection appliance on a production line according to at least some embodiments of the present disclosure;

FIGS. 2A-2L show a mounting assembly and camera assembly of an automated visual inspection appliance according to at least some embodiments of the present disclosure;

FIGS. 3A-3C show a mounting assembly and camera assembly of an automated visual inspection appliance according to at least additional embodiments of the present disclosure;

FIG. 4 shows a mounting assembly and camera assembly of an automated visual inspection appliance according to at least some other embodiments of the present disclosure;

FIG. 5 shows a mounting assembly and camera assembly of an automated visual inspection appliance according to at least some additionally other embodiments of the present disclosure;

FIGS. 6A-6C show embodiments of a light source of a VIA according to at least some embodiments of the present disclosure;

FIGS. 7A-7C are illustrative schematic drawings showing a multi-camera automated visual inspection appliance on a production line and a related illustrative screenshot according to at least some embodiments of the present disclosure;

FIGS. 8A and 8B show respectively a movement graph and images captured by a camera assembly and a flow diagram illustrating choice of an optimal image according to at least some embodiments of the present disclosure; and

FIG. 9 shows a mounting assembly and camera assembly of an automated visual inspection appliance according to at least some embodiments of the present disclosure.

### DETAILED DESCRIPTION

The present disclosure in at least some embodiments is an automated visual inspection appliance for a production line that can be easily and quickly installed for inspection without significant tailored integration. In one embodiment, fast and accurate installation of the inspection camera and lighting is enabled using a combination of an installation planner application, a customizable, easily assembled mounting assembly, and a combined camera/lighting assembly.

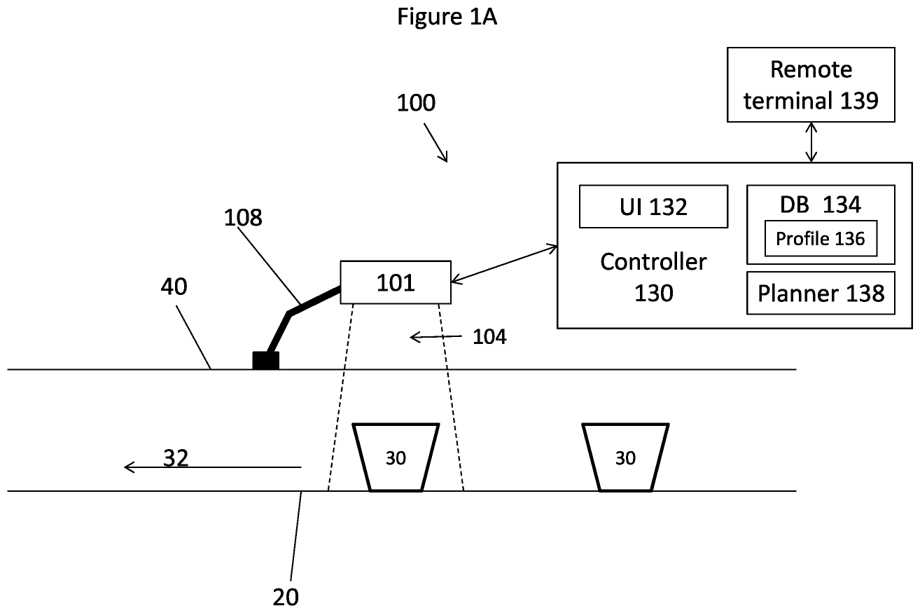

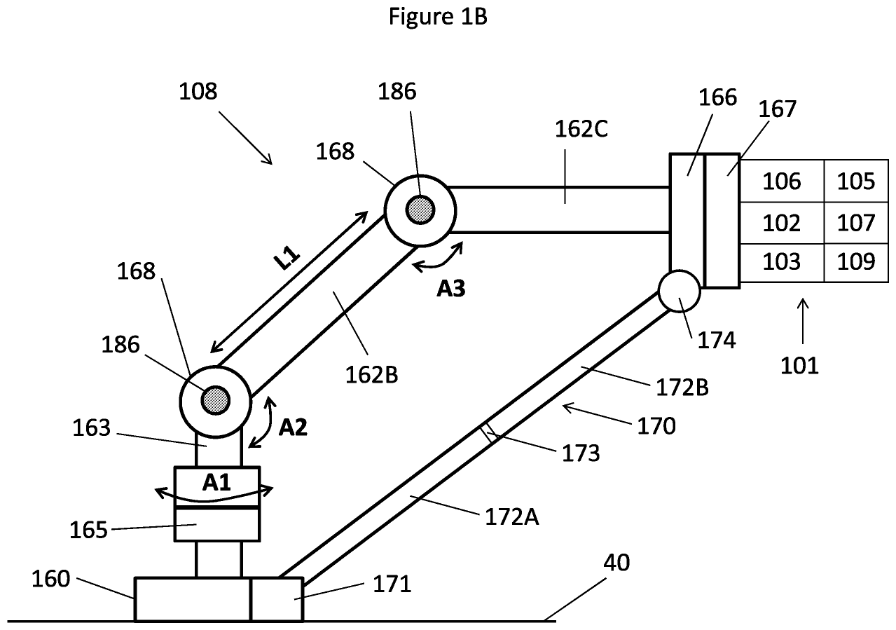

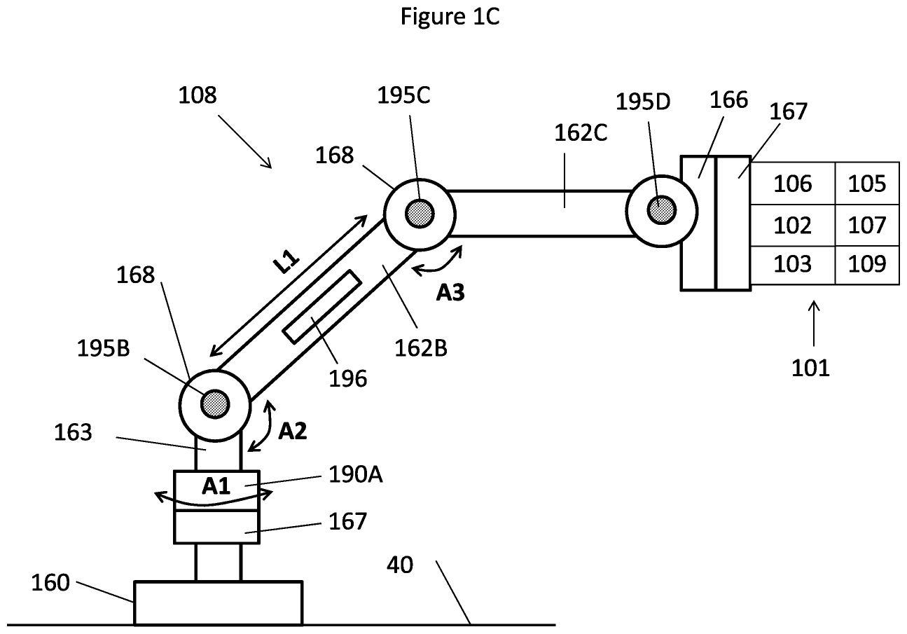

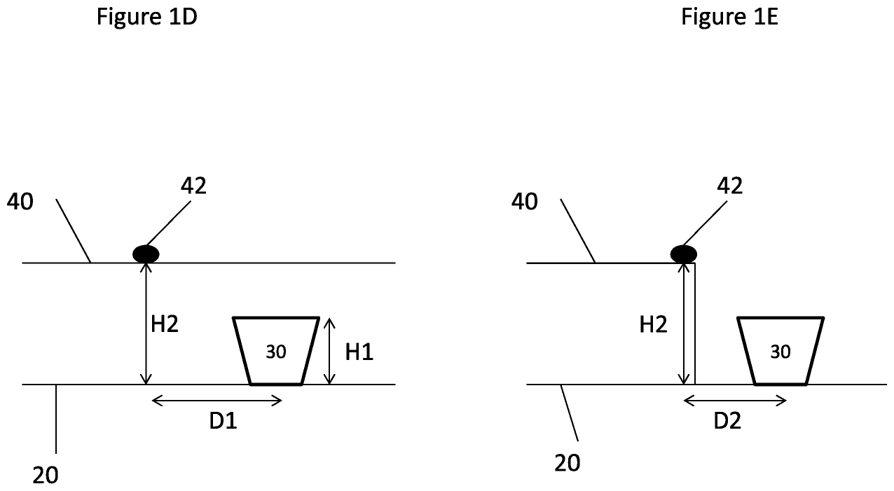

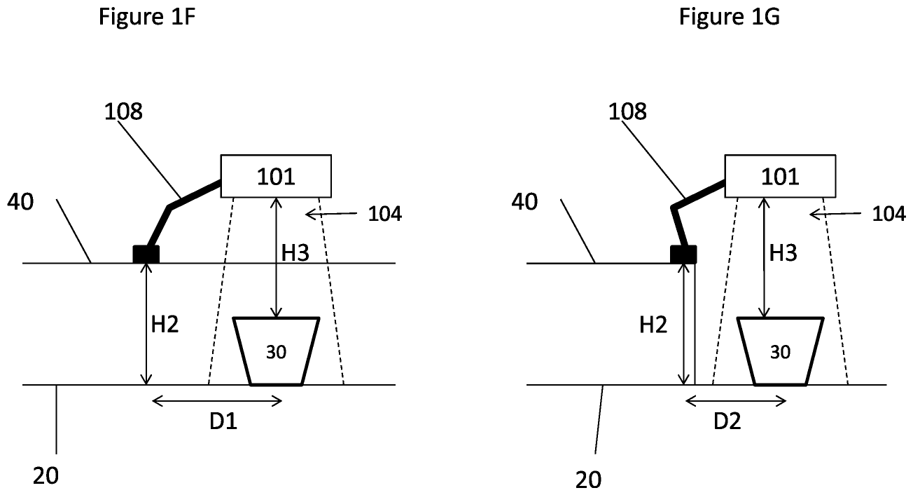

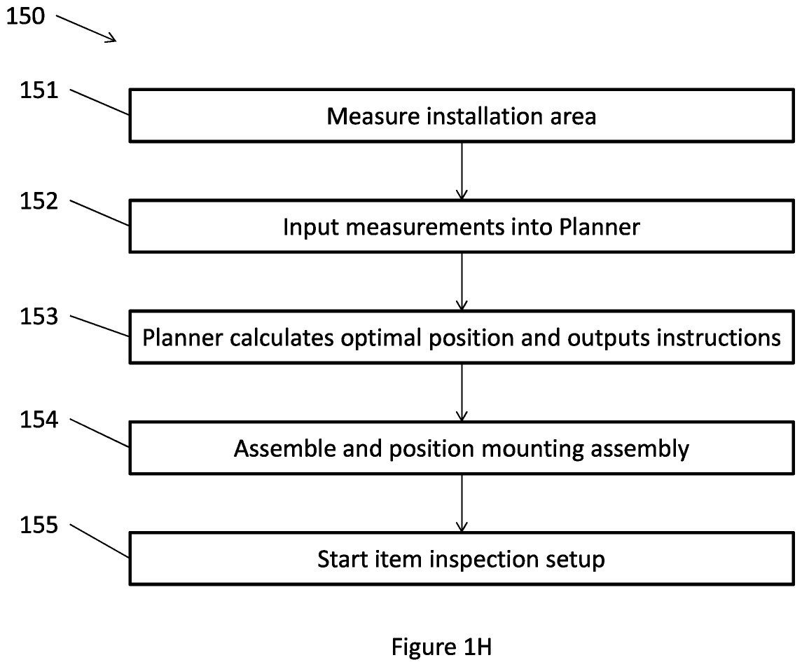

Reference is now made to FIGS. 1A-1G and 1H which are respectively illustrative schematic drawings and a flow diagram showing installation of an automated visual inspection appliance on a production line according to at least some embodiments of the present disclosure. As shown in figures 1A and 1B an installed automated visual inspection appliance (VIA) 100 comprises controller 130, camera assembly 101, and mounting assembly 108. Camera assembly 101 comprises camera 102, and light source 106. VIA 100 may be provided as an integrated appliance for use in a manufacturing environment.

Camera 102 comprises a CCD or CMOS or other appropriate imaging chip. Camera 102 is a 2D camera or optionally a 3D camera. Optionally camera 102 comprises the camera integrated into a mobile device such as a smartphone or tablet where the device is attached to mounting assembly 108. Camera 102 may comprise a lens 103 placed over the lens of camera 102 or directly over the imaging chip of camera 102. Lens 103 is any suitable lens including but not limited to: polarizing lens, tele-centric lens, narrow band, zoom lens, or other lens.

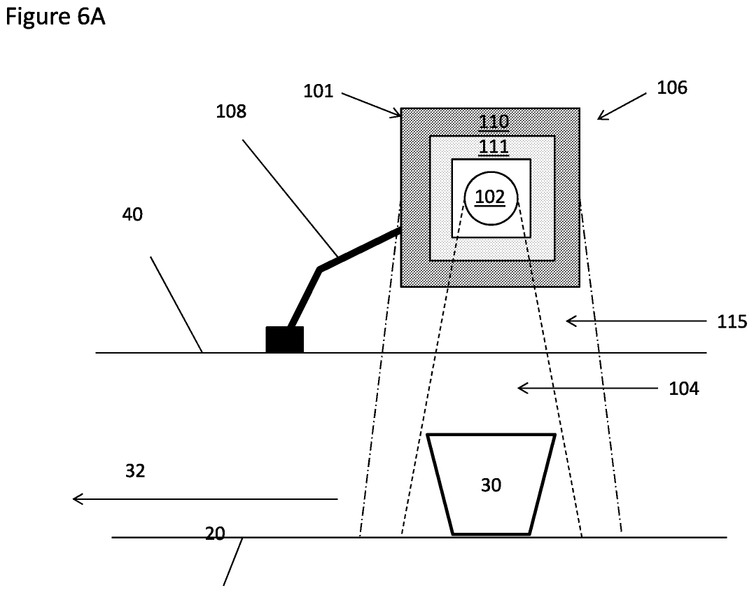

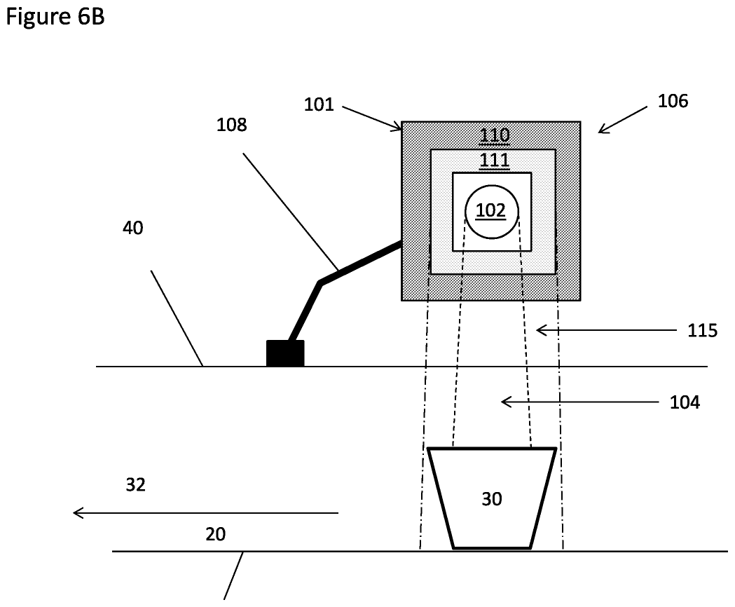

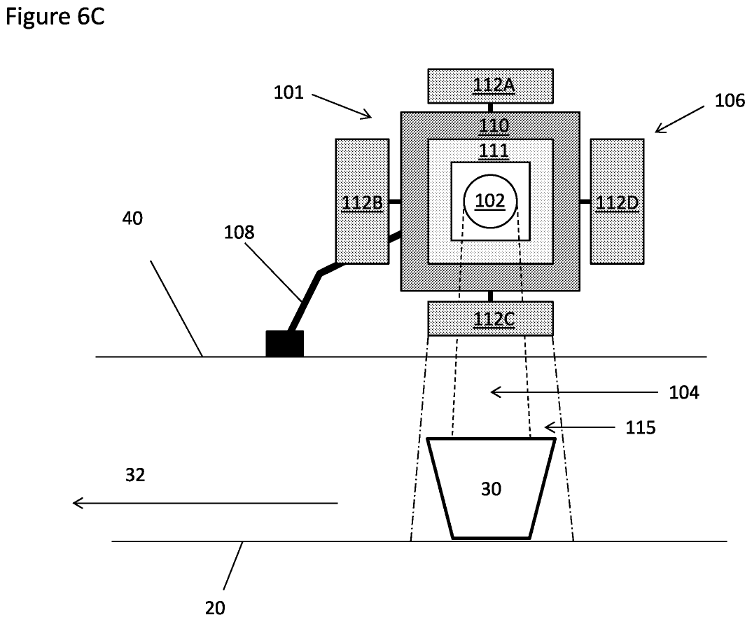

Light source 106 comprises LEDs or other light source as known in the art. The intensity (brightness) of light source 106 can be adjusted. Optionally light source 106 comprises RGB LEDs. Optionally, the color of light source 106 can be adjusted. Optionally, light source 106 comprises multiple controllable segments, each of which can be activated or provided with the same or different intensity and/or color. For example but without intention to be limiting, light source 106 may comprise a circular array of LEDs surrounding camera 102 lens, where radial portions of circular light source 106 are controlled individually or alternatively the intensity and/or color of every LED or groupings of LEDs, can be controlled individually. Light source 106 optionally comprises a diffuser 105. Camera assembly 101 optionally comprises a light sensor 107 for determining the intensity of ambient light in the environment of camera assembly 101. Light source 106 optionally comprises concentric arrangements of lights or side lights as described further below with reference to FIGS. 6A-6C.

Light source 106 is shown as positioned above camera 102 for simplicity of the figures but this position should not be considered limiting. Optionally, light source 106 is mounted on the side of or below camera 102. Light source 106 is preferably attached to and surrounds or is otherwise fixed in relation to the lens of camera 102 so as to illuminate the field of view 104 of camera 102 or portions thereof, wherein the illuminated portions are illuminated contiguously or separately. Camera assembly 101 is attached to mounting assembly 108. Alternatively, camera 102 and light source 106 are separately attached to mounting assembly 108 allowing individual adjustment of either.

Mounting assembly 108 comprises mounts, segments and fasteners allowing adaptation and adjustment of mounting assembly 108 for optimal positioning of camera 102 and light source 106.

In one embodiment, a system for positioning a camera for automated visual inspection of an item on an inspection line, may include a controller in communication with a user interface device. The controller receives, via the user interface device, measurements of a position of an item to be inspected relative to a mounting point of a mounting assembly for the camera, calculates an optimal position for the camera based on the received measurements and controls movement of components of the mounting assembly for the camera, according to the optimal position.

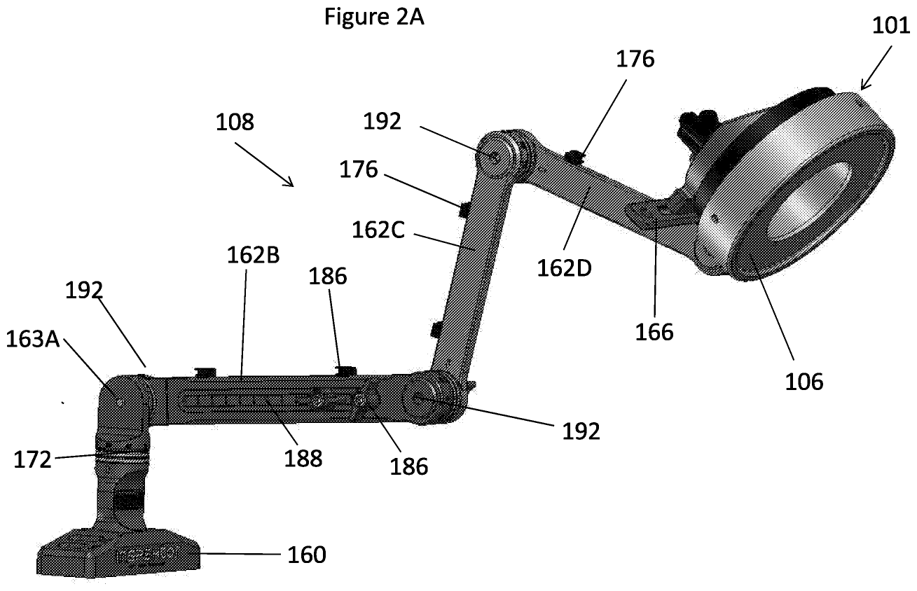

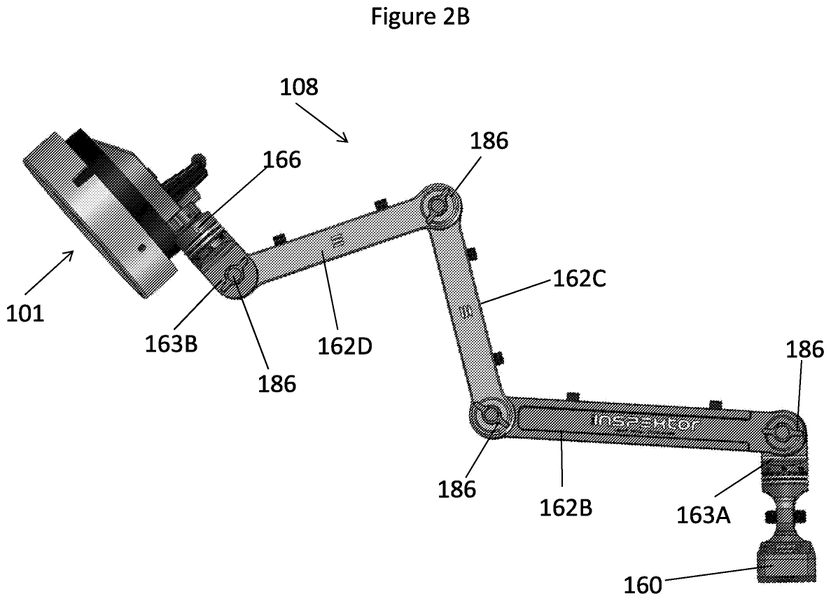

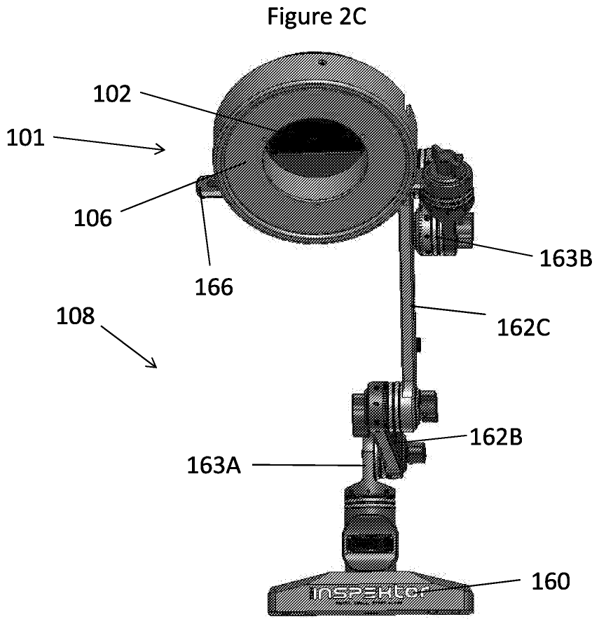

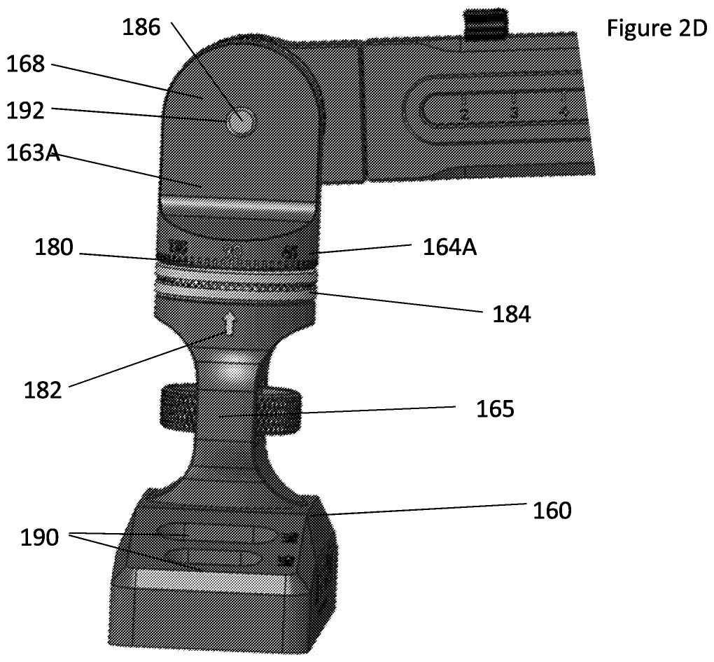

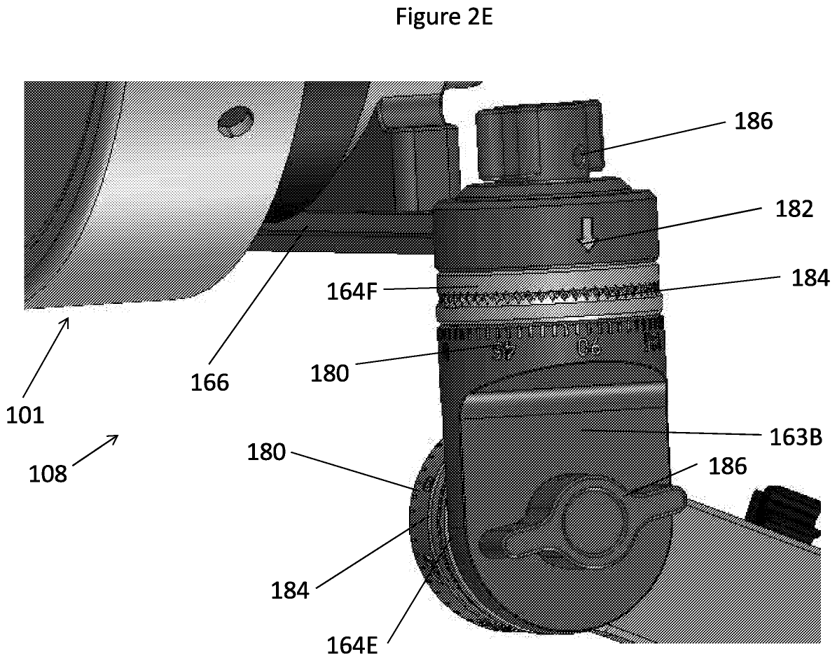

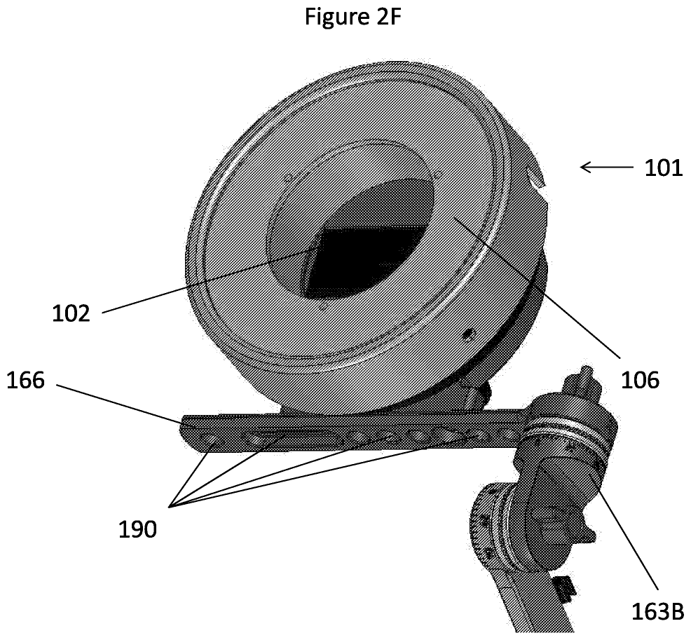

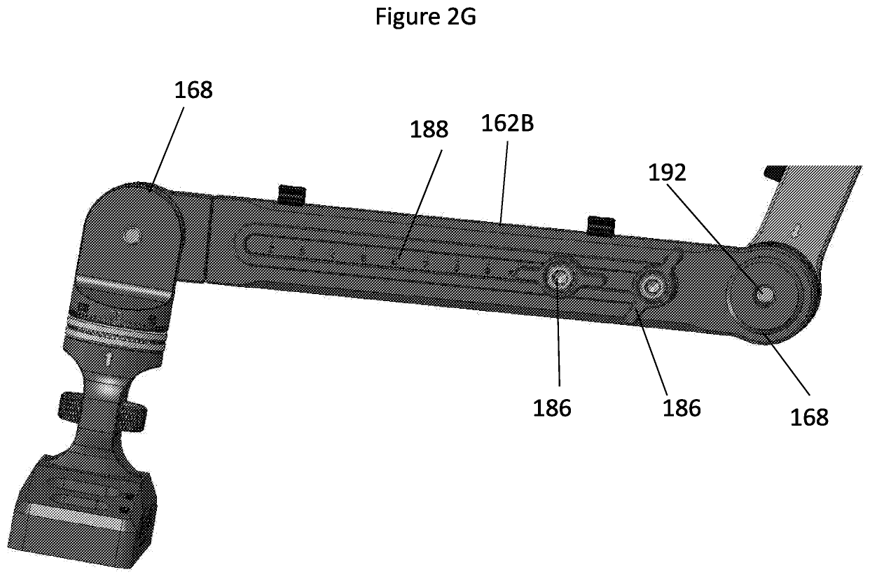

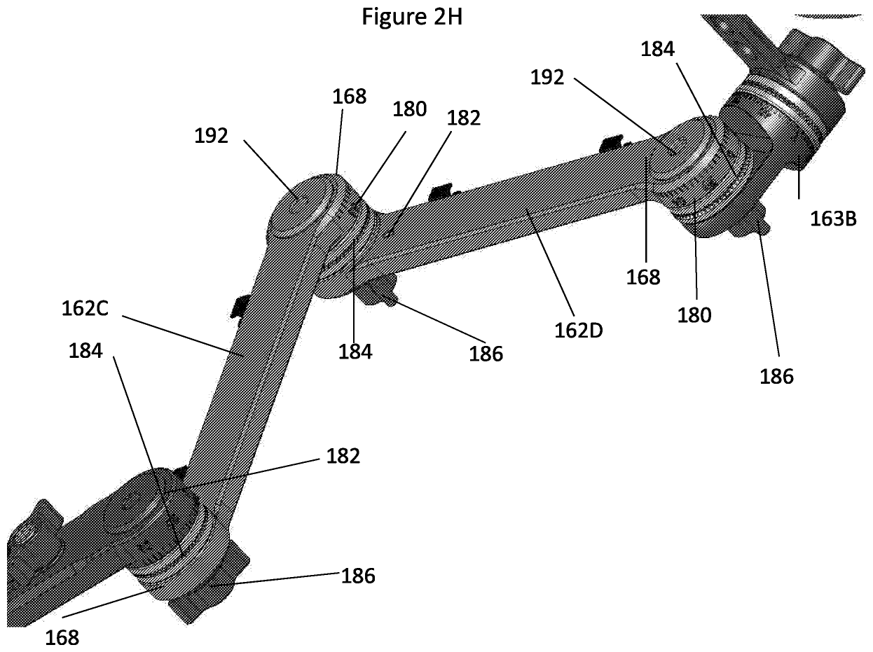

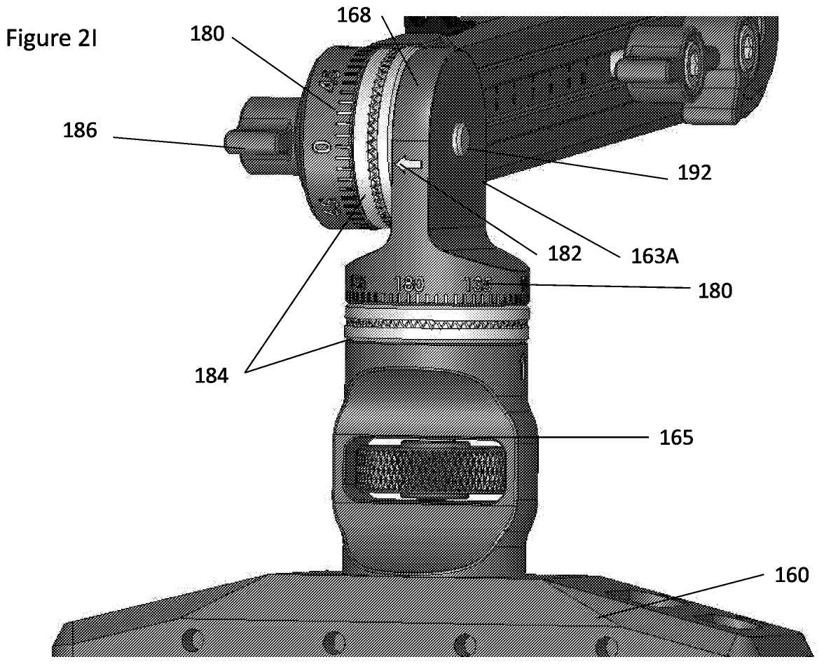

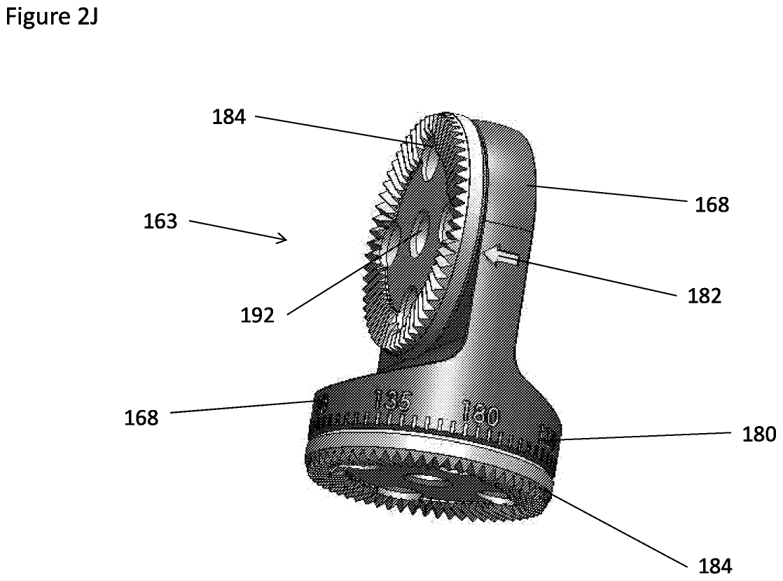

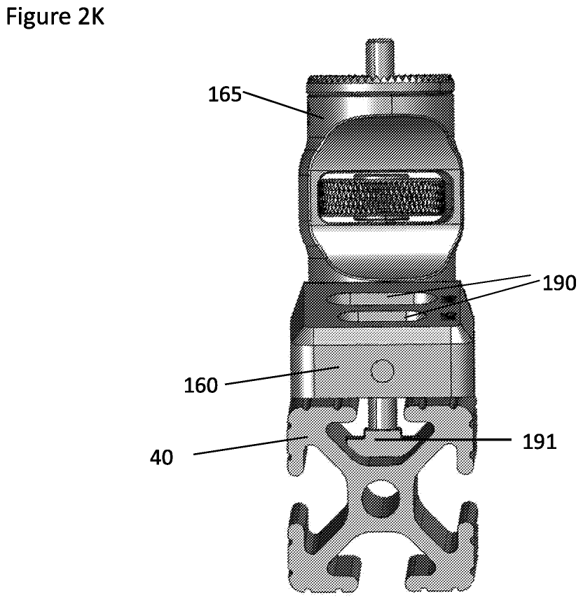

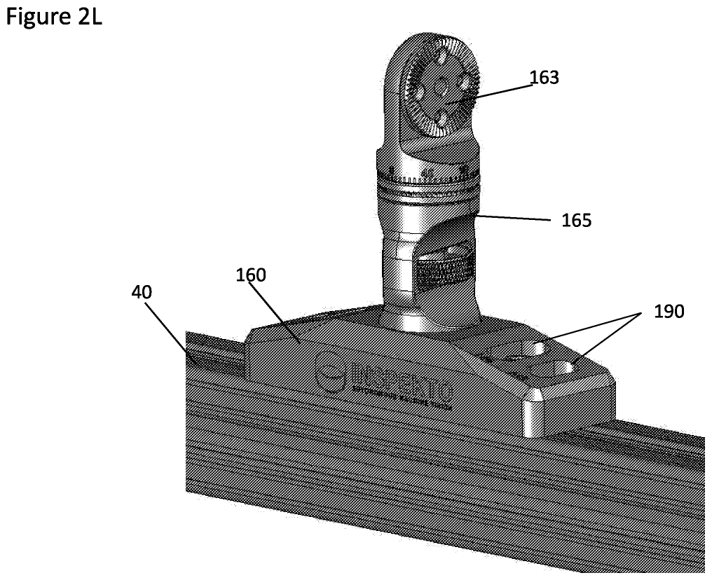

A preferred embodiment of mounting assembly 108 is described below with reference to FIGS. 2A-2L.

Camera assembly 101 is positioned using mounting assembly 108 such that items 30 to be inspected are within the field of view (FOV) 104 of camera 102. Mounting assembly 108 is attached to a mounting surface 40. Surface 40 optionally comprises an aluminum profile including grooves for attachment of mounting brackets. Surface 40 is optionally a pipe of any shape. Surface 40 may remain in a fixed position relative to item 30 or alternatively may move so as to repeatedly bring camera assembly 101 into a position where items 30 to be inspected are within the field of view 104 of camera 102. A non-limiting example of a movable mounting surface 40 is a robot arm. Alternatively, items 30 to be inspected may be placed on an inspection line 20 which comprises means for supporting and moving items 30 such as but not limited to a conveyor belt, or a cradle or another holding apparatus, moving in direction 32 while camera assembly 101 remains stationary, such that first item 30 is brought into FOV 104 followed by second item 30 which is brought into FOV 104, and so forth. Alternatively, items 30 are successively placed in FOV 104 and then removed such as by a robot or human operator. Although the embodiments herein are shown as being on a horizontal conveyor moving in direction 32, this should not be considered limiting and optionally any other options for surface 40 and inspection line 30 may be implemented.

Where reference is made to FOV 104 herein it is to be understood that in some embodiments, light source 106 is positioned to illuminate FOV 104.

Camera 102 and light source 106 may be in communication with controller 130. Controller 130 is a computing device as defined herein. Controller 130 comprises one or more processors (not shown) such as but not limited to a central processing unit (CPU), a graphics processing unit (GPU), a digital signal processor (DSP), a microprocessor, a controller, a chip, a microchip, an integrated circuit (IC), or any other suitable multi-purpose or specific processor or controller. Controller 130 may control camera 102 and light source 106 or any of its components or controllable segments as described above, which may or may not be activated or controlled depending on the item being imaged or the inspection lighting environment.

Controller 130 may alter the intensity or color of light source 106 depending on the item being imaged or the inspection lighting environment. Controller 130 may alter the intensity or color of light source 106 for regions of particular interest within the illuminated area. Controller 130 may alter the intensity or color of light source 106 so that images taken by camera 102 of item 30 are not over or under exposed. Controller 130 may cause lens 103 to rotate. In one embodiment lens 103 is rotatable and when lens 103 is a polarizing lens the polarizing lens is adjusted to minimize reflections from item 30. Controller 130 may control camera 102 parameters including but limited to focus, white balance, exposure, zoom, any camera mechanical options and any other adjustable parameters of camera 102.

Optionally camera 102 controls light source 106. In this case camera 102 may alter the intensity or color of light source 106 depending on the item being imaged or the inspection lighting environment. Camera 102 may alter the intensity or color of light source 106 for regions of particular interest within the illuminated area. Camera 102 may alter the intensity or color of light source 106 so that images taken by camera 102 of item 30 are not over or under exposed.

Controller 130 further comprises a memory unit (not shown) which stores executable instructions that, when executed by the processor, facilitate performance of operations of the processor. The memory unit may also store at least part of the image data received from camera 102. Non-limiting examples of memory units include random access memory (RANI), dynamic RAM (DRAM), flash memory, volatile memory, non-volatile memory, cache memory, a buffer, a short term memory unit, a long term memory unit, or other suitable memory units or storage units. Controller 130 comprises profile database (DB) 134 which is stored in the memory unit.

Controller 130 further comprises a user interface (UI) 132. UI 132 may comprise a monitor or screen and notifications to a user may be visual (e.g., text or other content displayed on the monitor). Alternatively or additionally UI 132 comprises a light that may light up or change color. Alternatively or additionally UI 132 comprises an audio player to emit a sound. UI 132 preferably comprises means for accepting user input such as a touch screen, keyboard and/or mouse. Optionally, UI 132 is provided on a multi-purpose device such as a smartphone, tablet or personal computer.

Controller 130 comprises planner application 138 or software module. Based on measurements of the installation area planner application 138 calculates the optimal position for camera assembly 101 and outputs instructions for assembly and adjustment of mounting assembly 108 that will result in positioning of camera assembly 101 in this optimal position. User interaction with planner 138 is via UI 132. Alternatively planner application 138 runs on a stand-alone computing device.

VIA 100 optionally comprises a remote terminal 139 for remote manipulation of controller 130. Remote terminal 139 is optionally a web browser and controller 130 provides a web service for control of controller 130 including access to UI 132 and control of planner application 138.

As shown in FIG. 1B, mounting assembly 108 preferably comprises multiple adjustable parts, varying in size and varying in their capacity for adjustment, that enable the positioning of camera assembly 101 into any required position. In one embodiment a mounting assembly for a camera on an inspection line, includes a mount having two ends. One end is configured to be attached to an inspection line mounting surface and the other end is configured to be attached to a camera. The end attachable to the mounting surface includes at least one hole through which a fixing mechanism can fix the mount to an inspection line mounting surface. This end of the mount is configured to allow flexibility of positioning of the mount on the mounting surface.

In the embodiment of FIG. 1B, mounting assembly 108 comprises segments 162B and 162C, and mounts 160 and 166. These are joined together by fixing fasteners 186. While FIG. 1B shows two segments 162 this arrangement should not be considered limiting and in practice, mounting assembly 108 can comprise more or less segments 162 as are required to position camera assembly 101 in its optimal position.

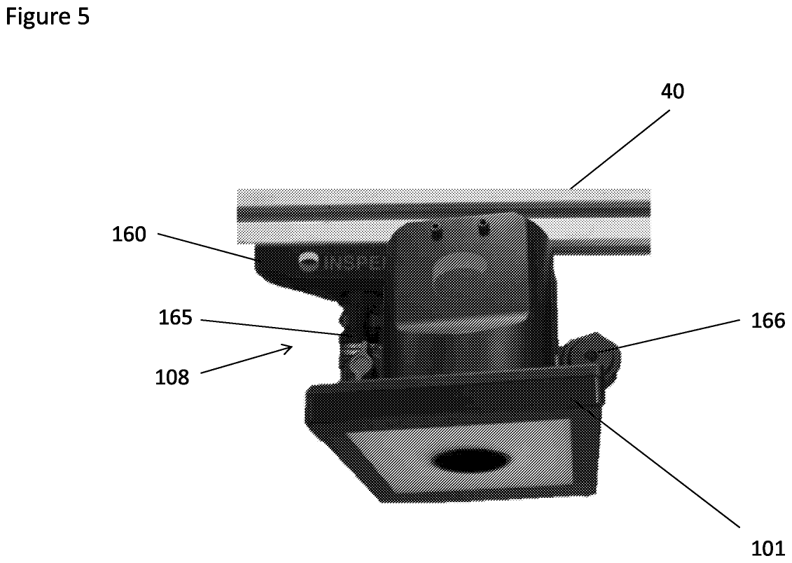

Mounting surface mount 160 enables attachment of mounting assembly 108 to mounting surface 40. Mount 160 preferably comprises mounting holes 190 (FIG. 2D) through which bolts (not shown) or other fixing mechanisms such as clamps, nuts, sliding blocks, springs, connectors, and/or brackets can be threaded for attachment to surface 40. Alternatively, where mounting surface 40 mount comprises aluminum profiles, such as but not limited to those manufactured by Bosch Rexroth®, mount 160 is adapted to attach to these profiles and may include attachment means 191 (shown in FIG. 2K) including but not limited to one or more clamps, bolts, nuts, t-nuts sliding blocks, springs, connectors, and brackets such as but not limited to those manufactured by Bosch Rexroth®. Optionally any attachment means 191 known in the art can be used to fix mount 160 to mounting surface 40. Optionally mount 160 is adapted for mounting to any form of mounting surface 40 including but not limited to a circular or elliptical pipe. In one embodiment, the mount 160 includes a plurality of mounting holes 190 in close proximity to each other. In another embodiment mounting holes 190 are preferably oblong shaped, e.g., rectangular or oval holes enabling flexibility of positioning of mount 160 before fixing of mount 160 with attachment means to mounting surface 40. Mounting surface mount 160 is connected to arm base 165 for connection of mount 160 to segments 162, rosettes 163, or directly to camera mount 166 (FIG. 5) or directly to camera assembly 101. A rosette 163 is a connector for changing the plane of connection or angle of connection between components of the mounting assembly 108. As used herein the term “segment” also includes rosette segments. An exemplary rosette is shown in FIG. 2J. Rosette 163 comprises connectors 168, interlocking teeth 184, angle markings 180 and angle pointers 182.

Camera mount 166 enables attachment of mounting assembly 108 to camera assembly 101. Camera mount 166 preferably comprises multiple mounting holes 190 through which fixing mechanisms such as bolts (not shown) or other fixation means can be threaded for attachment to assembly 101. Optionally the positioning of camera assembly 101 can be adjusted by fixing camera assembly 101 to a hole 190 in a different position on mount 166. Optionally any attachment means known in the art can be used to fix camera mount 166 to camera assembly 101. Optionally camera assembly 101 comprises a mount for direct attachment to segments 162 B or C or surface mount 160. Camera mount 166 further comprises a connector 168 for connection of camera mount 166 to segments 162 B or C, rosettes 163, or directly to surface mount 160. Connectors 168 comprise a hole 192 through which a fixing fastener 186 can be inserted. Alternatively any connection mechanism can be used for connecting mounts 160 and 166 to each other or to segments 162B or C. Connectors 168 preferably comprise angle markings 180 and corresponding arrow indicators, such as angle pointers 182 (such as shown in FIGS. 2D, H, I and J) to enable exact adjustment of angles A1, A2, and A3.

Segments 162B and C preferably terminate on both ends in connectors 168 where each connector 168 comprises a central hole 192 through which a fixing fastener 186 can be inserted to join two segments or connect a segment 162B or C to a rosette 163, surface mount 160 and/or camera mount 166. Alternatively any joining mechanism may be provided to connect segments 162B or C to each other or to rosettes 163 or mounts 160, 166. Connectors 168 are preferably circular as shown but any suitable shape may be used. Connectors 168 preferably comprise angle markings 180 and corresponding angle pointers 182 (such as shown in FIGS. 2D, H, I and J) to enable exact adjustment of angles A1, A2, and A3. Segment connections in assembly 108 are preferably provided in at least two planes to enable adjustment of mount assembly 108 in any direction.

Fixing fasteners 186 can be loosened to adjust angles A1, A2, and A3 and tightened to fix angles A1, A2, and A3. Fixing fasteners 186 preferably comprise a bolt/nut arrangement as known in the art or alternatively may comprise any attachment mechanism that can be loosened and tightened. Segments 162, which are configured to connect between a mount and a camera, are optionally of variable length such as segment 162B, which is an extendable segment. Varying length segment 162B comprises length markings 188 (FIG. 2G) for exact adjustment of the segment 162B length L1 to a desired length.

Segments 162, mounts 160 and 166, rosettes 163, and fasteners 186 are all collectively referred to herein as the parts or components of mounting assembly 108. Optionally each part of mounting assembly 108 including segments 162, rosettes 163, mounts 160 and 166 and fasteners 186 comprises a marking such as a text label or number to uniquely identify each part such that these can be correlated with the same parts described in assembly instructions for the mounting assembly 108.

As above, VIA 100 is mounted on mounting surface 40 which forms part of the production environment. Mounting surface 40 might therefore impart movement or vibrations from the production surfaces to mounting assembly 108 which may in turn cause camera assembly 101 to vibrate, potentially disrupting image capture. VIA 100 is therefore provided with one or more anti-vibration mechanisms enabling VIA 100 to function while mounted on mounting surface 40.

Mounting assembly 108 or camera assembly 101 comprises one or more mechanical motion stabilizers 167 to limit unintended movement of the camera and to stabilize camera assembly 101 such that the image captured by camera 102 is not disrupted by vibrations or movement of mounting surface 40 or inspection line 20 such as when items 30 are moved and stop suddenly near camera assembly 101. The positions of stabilizers 167 as shown in FIGS. 1B and 1C should not be considered limiting as stabilizers 167 are positioned where needed to absorb vibrations. One or more stabilizers 167 are optionally provided.

Alternatively or additionally mounting assembly 108 comprises a stabilizing arm 170. Stabilizing arm 170 comprises: stabilizing arm mount 171 for attachment of stabilizing arm 170 to a mounting surface 40; stabilizing arm segments 172A and 172B; stabilizing arm extender 173 for joining stabilizing arm segments 172A and 172B and optionally for adding more stabilizing arm segments 172 using another extender 173; and stabilizing arm connector 174 for joining stabilizing arm 170 to camera assembly mount 166. Stabilizing arm 170 limits the movement of camera assembly 101 such as caused by movement of the production line elements that may cause mounting surface 40 to move. Limiting the movement of camera assembly 101 prevents blurring of images from camera 102;

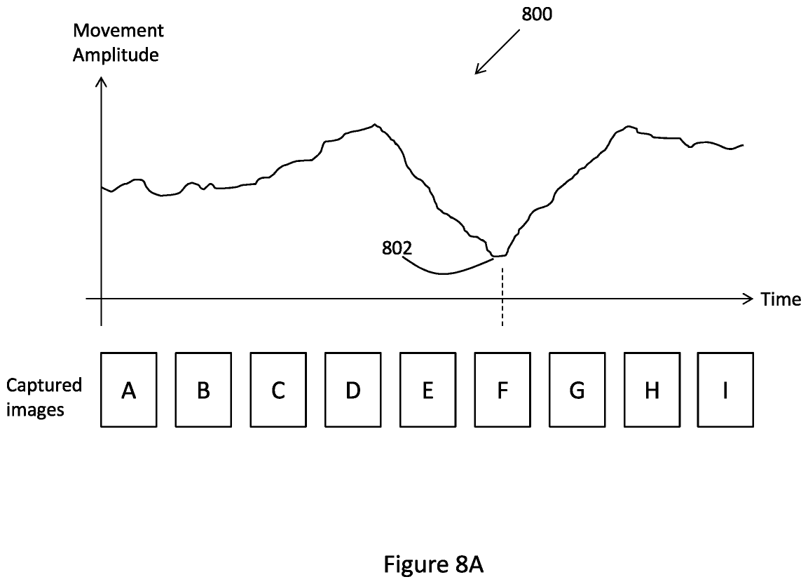

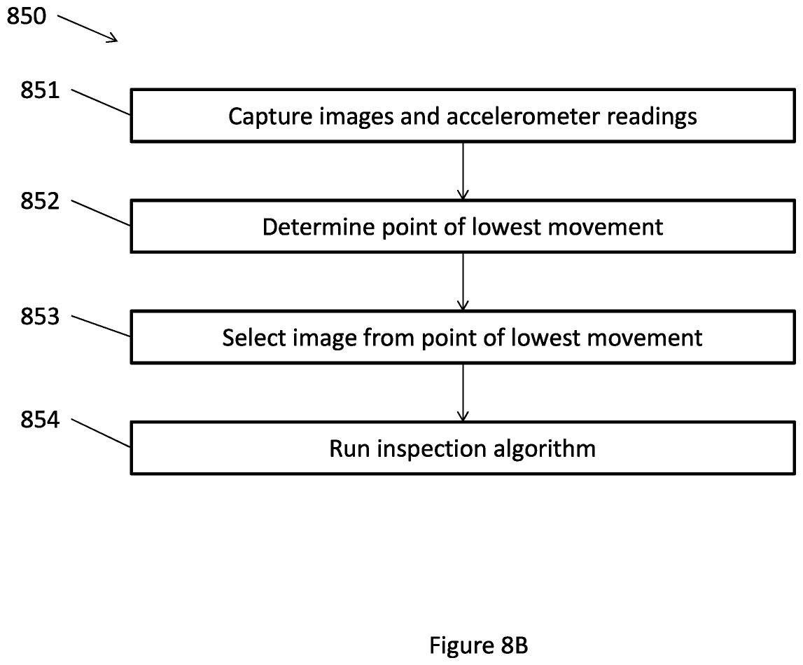

Alternatively or additionally camera assembly 101 comprises accelerometer 109. As used herein “accelerometer” 109 may comprise one or more motion sensitive device, such as a gyroscope and an accelerometer. Alternatively, during the inspection process multiple image frames are captured by camera 102 of item 30 and controller 130 selects the image with the least vibration-induced distortion using the data collected from accelerometer 109 as described further below with reference to FIGS. 8A and 8B.

In some embodiments a motion sensitive device is in communication with controller 130 and the controller 130 can generates a warning signal (e.g., via the user interface device 132) to a user based on input from the motion sensitive device, namely, the user can be warned when motion of the camera is sensed.

Alternatively, during the inspection process multiple image frames are captured by camera 102 of item 30 and controller 130 combines multiple of the collected images to form a stabilized image. The stabilized image is created by using the motion vector for each image frame as estimated from accelerometer 109 and then ‘shifting’ each captured image frame in reverse according to its respective motion vector, all relative to a selected master image.

In the embodiment of FIG. 1C, mounting assembly 108 comprises segments 162B and 162C, rosettes 163, and mounts 160 and 166. These are joined together by independently-controlled servomotors 195B, C and D (collectively—servomotors 195). Variable length segment 162B comprises servomotor 196 for adjustment of the segment 162B to a desired length L1. Servomotors 195 and 196 comprise gearing (not shown) to move or adjust a component of the assembly, sensors (not shown) for sensing the relative positions of rosettes 163 and segments 162, and connection adaptors (not shown) for connection to rosettes 163 and segments 162 and manipulation of these. Servomotors 195 and 196 are in wired or wireless communication with controller 130 such that controller 130 can adjust mounting assembly 108 by manipulating servomotors 195 and 196 to move camera assembly 101 into a required position. While FIG. 1C shows two segments 162 and four servomotors 195 and 196, this arrangement should not be considered limiting and in practice, mounting assembly 108 can comprise more or less segments 162 and/or servomotors 195 and 196 as are required to position camera assembly 101 in its optimal position.

Mounting surface mount 160 and camera mount 166 have the same functionality as described above with reference to FIG. 1B. Camera mount 166 optionally also comprises a servomotor 195D (as shown in FIG. 1C). Segments 162 and rosettes 163 preferably terminate on both ends in connectors 168 where each connector 168 is attached to a servomotor 195 to join two segments or segment and rosette 163 such that servomotor 195 can move each segment 162 relative to its adjoining segment 162 around connector 168. Servomotors 195 enable exact adjustment of angles A1, A2, and A3. Segment connections in mount assembly 108 are preferably provided in at least two planes to enable adjustment of mount assembly 108 in any direction. Segments 162 may be of varying lengths.

All or some of the components of VIA 100 may be in wired or wireless communication.

As shown in FIG. 1D-1H, the installation of mounting assembly 108 and camera assembly 101 is performed as per process 150. Process 150 may include the use of planner application 138 as in steps 152-153 or alternatively steps 152-153 are skipped and mounting assembly 108 is assembled and adjusted, as in step 154, manually without the aid of planner 138 to position camera assembly 101 facing item 30. Mounting assembly is adapted, by use of multiple easy to assemble parts, to be assembled by an untrained user without the help of a system integrator.

Alternatively using the embodiment of FIG. 1C, controller 130 manipulates mounting assembly 108 using servomotors 195 and 196 to move camera assembly 101 while monitoring the view captured by camera 102 until controller determines that camera assembly 101 is in an optimal position for inspection of item 30. Alternatively, using the embodiment of FIG. 1C, an operator of controller 130 manipulates servomotors 195 and 196 of mounting assembly 108 using UI 132 of controller 130 to move camera assembly into an optimal position for inspection of item 30. Alternatively using the embodiment of FIG. 1C, an operator of controller 130 is guided by controller 130 to manipulate servomotors 195 and 196 of mounting assembly 108 using UI 132 of controller 130 to move camera assembly 101 into an optimal position for inspection of item 30 where controller 130 monitors the view captured by camera 102 to provide guidance to the operator.

In step 151 measurements are made of the position of the item to be inspected relative to the mounting surface 40 of the mounting assembly 108. The list of measurements required is preferably provided by planner application 138 and is sufficient to enable planner application 138 to determine the optimal position of camera assembly as in step 153. For manual assembly of mounting assembly 108 fewer measurements may be made.

As shown in FIGS. 1D and 1E which show respectively exemplary front and side views of an item 30 on an inspection line 20, at least the following measurements are made: H1—the height of the surface to be inspected of item 30 above inspection line 20; H2—the height of mounting surface 40 above the production surface, e.g., inspection line 20, D1—the distance in the frontal plane between mounting point 42 of mounting assembly 108, and the center of item 30; D2—the distance in the side plane between mounting point 42 and the center of item 30. Additional measurements may include: mounting surface 40 orientation (vertical/horizontal) and/or angle (0-360 degrees); size of the inspected object (x, y, z where the object is a modelled as a 3D rectangular shape); the distance in a particular plane between mounting point 42 and the center of inspected item 30; and the distance in a particular plane between mounting point 42 and the stop-point (center of the production surface, e.g., inspection line 20 where item 30 is stopped for inspection). Optionally other measurements are made as required by the specific relationship between mounting point 42 and item 30.

In step 152, the measurements made in step 151 are input into the planner application 138, preferably by a user using UI 132. Optionally the measurements are entered by a remote operator via remote terminal 139. In step 153, based on the measurements provided in step 152, planner application 138 calculates the optimal position for camera assembly 101 that will result in FOV 104 sufficiently including item 30 or the surface of interest of item 30.

Further, non-limiting examples of the factors taken into account in determining the optimal position by planner application 138 include where:

camera assembly 101 is positioned at an optimal distance from the item 30 to be imaged such that item 30 is not too small or too large in the field of view;

camera assembly 101 is positioned at the correct angle to capture the surface of interest;

camera assembly 101 is positioned so as not to interfere with or disrupt the production or inspection line;

camera assembly 101 is positioned so that the moment of the installed mounting assembly 108 around mount 160 will be the minimum moment;

camera assembly 101 is positioned based on a combination of the above and optionally also other factors.

Planner application 138 then calculates the optimal configuration of mounting assembly 108 to position camera assembly 101 in this optimal position. While the position of camera assembly 101 is shown in the figures as being above item 30 it should be understood that the positional relationship of camera assembly 101 and item 30 will depend in practice on the aspect of item 30 that needs to be inspected. In the optimal configuration, planner application 138 preferably aims to reduce the number of steps required to assemble mounting assembly 108. Planner application 138 optionally reduces the number of parts of mounting assembly 108 that are needed to assemble mounting assembly 108 and optionally not all of the parts of mounting assembly 108 provided are required for positioning of camera assembly 101. In the optimal configuration, planner application 138 preferably aims to use those parts of mounting assembly 108 that will result in the most stable mounting assembly 108. The optimal configuration of mounting assembly 108 is preferably output by planner application 138 in the form of instructions for assembly and adjustment of mounting assembly 108. The assembly instructions are provided via UI 132 or are optionally exported for viewing on another device or are optionally printed.

Planner application 138 therefore outputs detailed instructions that can be easily followed in step 154 by any user including an untrained user to construct mounting assembly 108 from mounts 160, 166, rosettes 163, segments 162 and fasteners 186 provided as part of the inspection appliance. Optionally the instructions do not require usage of all of the parts of mounting assembly 108 provided. The instructions also describe attachment of the camera assembly 101 to mounting assembly 108. The instructions include the exact angles and segment lengths required to assemble and adjust mounting assembly 108 such that camera assembly 101 will be positioned in an optimal position. The instructions optionally include text and illustrations. Mounting assembly 108 is optionally provided disassembled or partially assembled and the instructions are used to complete assembly. Optionally the parts of mounting assembly 108 are labelled such as with a unique alphanumeric label and the instructions refer to these parts.

FIGS. 1F and 1G are respectively front and side illustrations of an exemplary configuration of mount assembly 108 such that camera assembly is positioned over item 30 at a height of H3 as planned by planner application 138.

Alternatively, following the calculation of the optimal position, and utilizing the embodiment of FIG. 1C, controller 130 manipulates mounting assembly 108 using servomotors 195 and 196 to move camera assembly 101 into the calculated optimum position.

It should be appreciated that should the inspection environment change, or the mounting assembly be moved to another location, or should it be necessary to inspect an item of significant size difference, the new dimensions can be input into planner application 138 and, following the steps above, mounting assembly 108 can be easily adjusted to fit the new situation. Alternatively mounting assembly 108 can be manually assembled in the new location.

In step 155 inspection of the items 30 can commence. VIA 100 may require a setup step for each item or stage of item that is to be inspected. In the setup step, at least two or more defect free samples of a manufactured item 30 of the same type are placed in succession within field of view 104 of camera 102. Each defect free sample of item 30 is imaged by camera 102. These images, which may be referred to as setup images, are optionally obtained by using different imaging parameters of camera 102 and lighting parameters of light source 106. The images comprise image data such as pixel values that represent the intensity of reflected light as well partial or full images or videos. Optionally during step 155, controller 130 may determine that the position of mounting assembly 108 requires fine tuning, such as when mounting assembly 108 is assembled and positioned manually without the use of planner application 138.

The setup images are analyzed by controller 130 using machine learning/artificial intelligence (AI) and computer vision algorithms to create a complete representation of item 30, for example, to collect information regarding possible 2D shapes and 3D characteristics of item 30 or to find uniquely discriminative features of item 30 and the spatial relation between these unique features. The analysis results in the creation of a profile 136, used for defect detection, gating, counting, or sorting on the production line which is stored in DB 134. Profile 136 optionally comprises the configuration instructions of step 153 for mounting assembly 108 such that these can be referenced if needed.

Following step 155 and based on the information collected from sample, defect-free items, the inspection process can begin and controller 130 can preferably detect further items of the same type even if these further items were never previously presented and determine whether these are defect-free. The images received from the inspection assemblies, which may be referred to as inspection images, are processed by controller 130 using machine learning/AI algorithms to detect defects or for gating, counting or sorting of items based on the loaded profiles 136.

Reference is now made to FIGS. 2A-2L which show a mounting assembly and camera assembly of an automated visual inspection appliance according to at least some embodiments of the present disclosure. As shown, mounting assembly 108 comprises mounts, segments and fasteners that provide for complete flexibility and simple yet accurate configuration of assembly 108 for optimal positioning of camera assembly 101 for visual inspection of an item 30. The embodiment of assembly 108 as shown in FIGS. 2A-2L is an illustrative embodiment of a mounting assembly 108 and should not be considered limiting. It should be appreciated that mounting assembly 108 can be assembled with fewer or more segments than shown.

As shown in FIGS. 2A, 2B and 2C, mount assembly 108 comprises mounts 160 and 166, rosettes 163, and segments 162B, 162C and 162D. Mounting surface mount 160 is for attachment of assembly 108 to a mounting surface as described above and camera mount 166 provides attachment of mounting assembly 108 to camera assembly 101 as above.

Mount 160 (FIG. 2D) further comprises mounting holes 190, fixing fastener 186 for attaching to rosette 163A, angle pointer 182 for pointing to the correct angle on the angle markings 180 of rosette 163A, and a fixing mechanism, such as, interlocking teeth 184 for fixing the angle of connection between components of the assembly, e.g., connection to rosette 163A.

Mount 166 (FIG. 2E and 2F) comprises mounting holes 190, angle pointer 182 for pointing to the correct angle on the angle markings 180 of rosette 163B, and interlocking teeth 184 for fixing the angle of connection to rosette 163B. Fixing fastener 186 (FIG. 2E) attaches mount 166 to rosette 163B.

Rosettes 163A and 163B (FIGS. 2D, 2E and 21) are mount attachment segments and are the segments joined respectively to mounts 160 and 166. Rosettes 163A and 163B comprise angle markings 180 for alignment with angle pointer 182 of mounts 160 and 166, mount holes 192 for insertion of fixing fasteners 186, angle pointers 182 for pointing to the correct angle on the angle markings 180 of segment 162B and 162D respectively, and interlocking teeth 184 for fixing the angle of connection with mounts 160 and 166 respectively and segments 162B and 162D respectively which are held together by fixing fasteners 186.

Segment 162B (FIG. 2G) is an extendable segment and comprises length markings 188 and fixing fasteners 186 such that segment 162B can be lengthened or shortened as part of the adjustment of assembly 108. Segment 162B terminates on both ends in circular connectors 168 with fastener holes 192 for joining with segment 162C and rosette 163A using fixing fasteners 186. Segment 162B comprises angle markings 180 on both ends as well as interlocking teeth 184 for fixing the angle of connection with segment 162C and rosette 163A.

Segments 162C and 162D (FIG. 2H) are fixed length segments and terminate on both ends in circular connectors 168 with fastener holes 192 for joining with other segments using fixing fasteners 186. Segments 162C and 162D comprise angle markings 180 on one end and angle pointers on their opposite ends as well as interlocking teeth 184 for fixing the angle of connection with other segments.

Mounting assembly 108 further comprises cable guides 176 for attachment of wired connections and power to camera 102 and light source 106. Alternatively mounting assembly 108 comprises internal wiring channels (not shown) such that wired connections to camera assembly 101 can be routed through these channels. Alternatively a combination of cable guides 176 and internal channels (not shown) are provided.

It should therefore be appreciated that by manipulation of segments 162 B-D including the accurate angle adjustments at the segment connection points, the lengthening or shortening of segment 162B, and the selection of mounting hole 190 for camera assembly 101 all contribute to the flexibility of mounting assembly 108 for configuration of assembly 108 such that camera assembly 101 can be simply and accurately positioned for inspection of item 30.

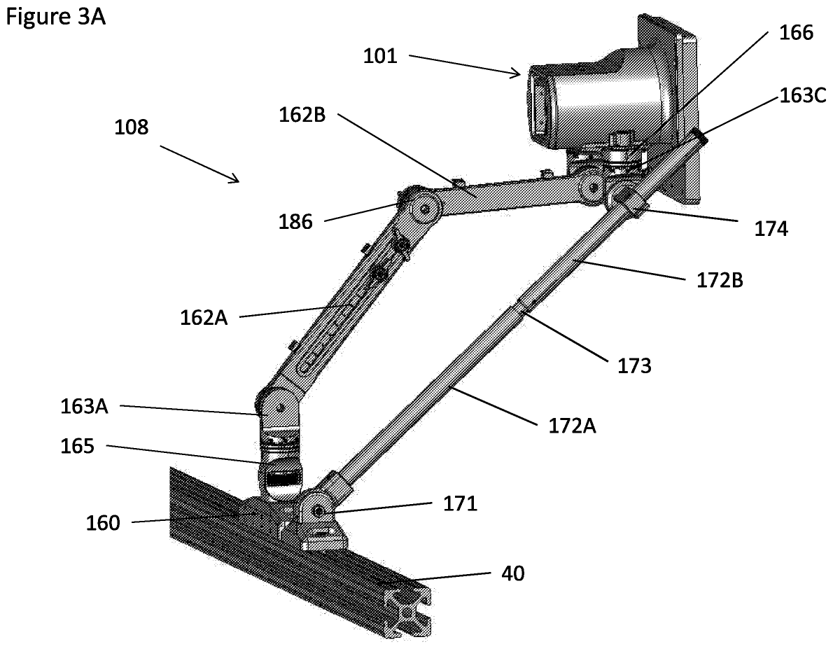

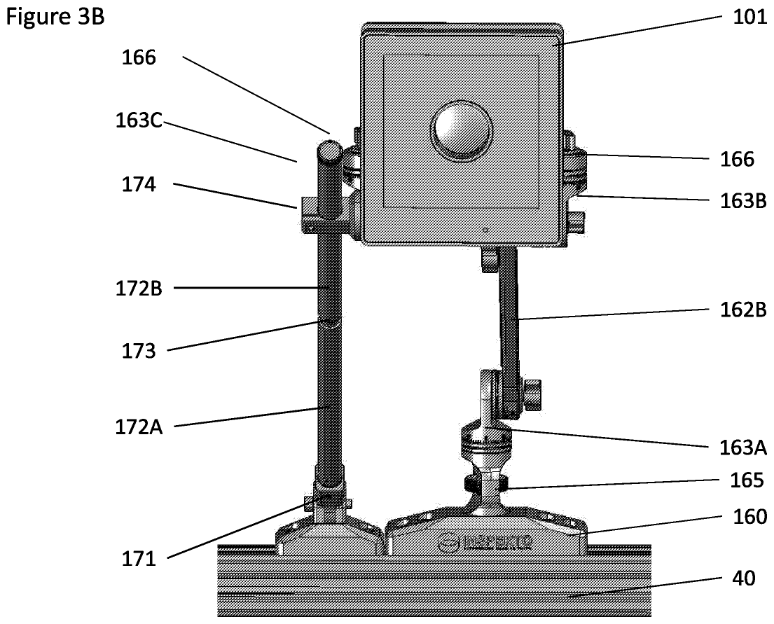

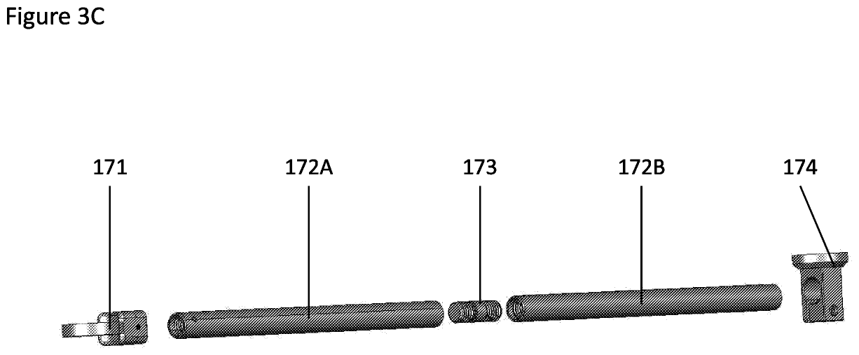

Reference is now made to FIGS. 3A-3C which show a mounting assembly and camera assembly of an automated visual inspection appliance according to at least some embodiments of the present disclosure. As shown, mounting assembly 108 comprises mounts, segments and fasteners that provide for complete flexibility and simple yet accurate configuration of assembly 108 for optimal positioning of camera assembly 101 for visual inspection of an item 30. The embodiment of assembly 108 as shown in FIGS. 3A-3B is an illustrative embodiment of a mounting assembly 108 and should not be considered limiting. It should be appreciated that mounting assembly 108 can be assembled with fewer or more segments than shown.

In the embodiment of FIGS. 3A-3C, mounting assembly 108 comprises mounts 160 and 166, arm base 165, rosettes 163A, B and C, and two segments 162A and 162B. Mounting assembly 108 further comprises stabilizing arm 170. Stabilizing arm 170 comprises: stabilizing arm mount 171 for attachment of stabilizing arm 170 to a mounting surface 40; stabilizing arm segments 172A and 172B; stabilizing arm extender 173 for joining stabilizing arm segments 172A and 172B and optionally for adding more stabilizing arm segments 172 using another extender 173; and stabilizing arm connector for joining stabilizing arm 170 to camera assembly mount 166 using rosette 163C. Stabilizing arm 170 limits the movement of camera assembly 101 such as caused by movement of the production line elements that may cause mounting surface 40 to move. Limiting the movement of camera assembly 101 prevents blurring of images from camera 102.

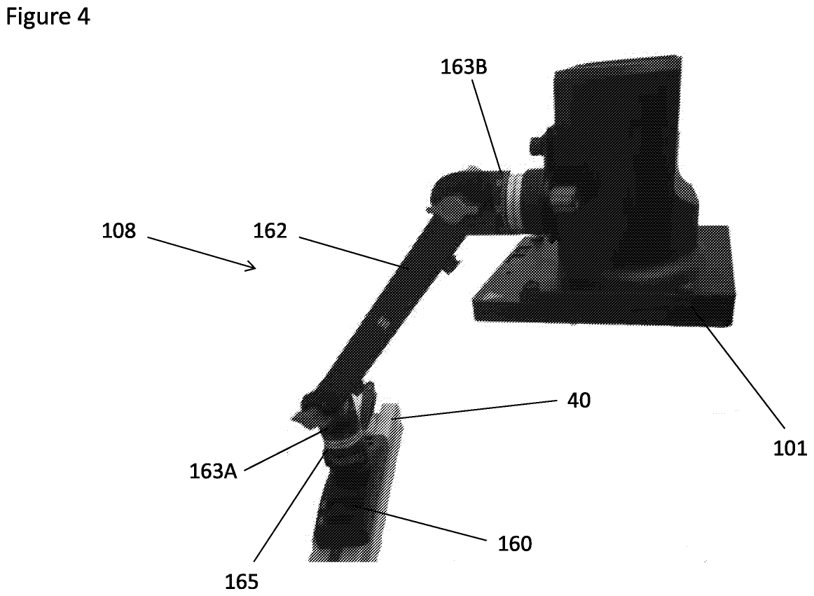

Reference is now made to FIG. 4 which shows a mounting assembly and camera assembly of an automated visual inspection appliance according to at least some embodiments of the present disclosure. In the embodiment of FIG. 4, mounting assembly 108 comprises mounts 160 and 166, arm base 165, rosettes 163A and 163B and only one segment 162. The embodiment of FIG. 4 illustrates the flexibility of mounting assembly 108 and the range of configuration options.

Reference is now made to FIG. 5 which shows a mounting assembly and camera assembly of an automated visual inspection appliance according to at least some embodiments of the present disclosure. In the embodiment of FIG. 5, mounting assembly 108 comprises mounts 160 and 166, and arm base with no segments or rosettes. The embodiment of FIG. 5 illustrates the flexibility of mounting assembly 108 and the range of configuration options.

Reference is now made to FIGS. 6A-6C which show embodiments of a light source of a VIA according to at least some embodiments of the present disclosure. As shown in FIG. 6A-6C light source 106 comprises two concentric squares of light positioned around camera 102; outer light source 110 and inner light source 111. Outer and inner light sources 110 and 111 may be activated together or individually depending on the lighting needs of VIA 100. Although two concentric squares are shown, it should be appreciated that any number of lighting sources may be provided in any shape that will provide the required lighting flexibility for VIA 100.

In FIG. 6A, the FOV 104 of camera 102 covers the entire top of item 30. In this case outer lighting source 110 and optionally inner lighting source 111 are used to create light coverage area 115. In FIG. 6B, camera 102 is zoomed such that FOV 104 of camera 102 covers only a portion of the top of item 30. In this case outer lighting source 110 is not needed and only inner lighting source 111 is activated to create light coverage area 115.

FIG. 6C shows light source 106 additionally comprising side lights 112A-D. In this illustration, four side lights 112A, 112B, 112C, and 112D are shown but this number should not be considered limiting and any number of side lights may be added to light source 106 to serve the needs of VIA 100. In FIG. 6C camera 102 is zoomed such that FOV 104 of camera 102 covers only a portion of the top of item 30. In this case only side light 112C is activated to create light coverage area 115. Side lights may also be used where lights 110 and 111 surrounding camera 102 may result in direct reflection off item 30 and where side lights will not cause such reflections. Alternatively any or all of light sources 110, 111, or 112A-D may be activated in any alternate combination depending on the lighting needs of VIA 100.

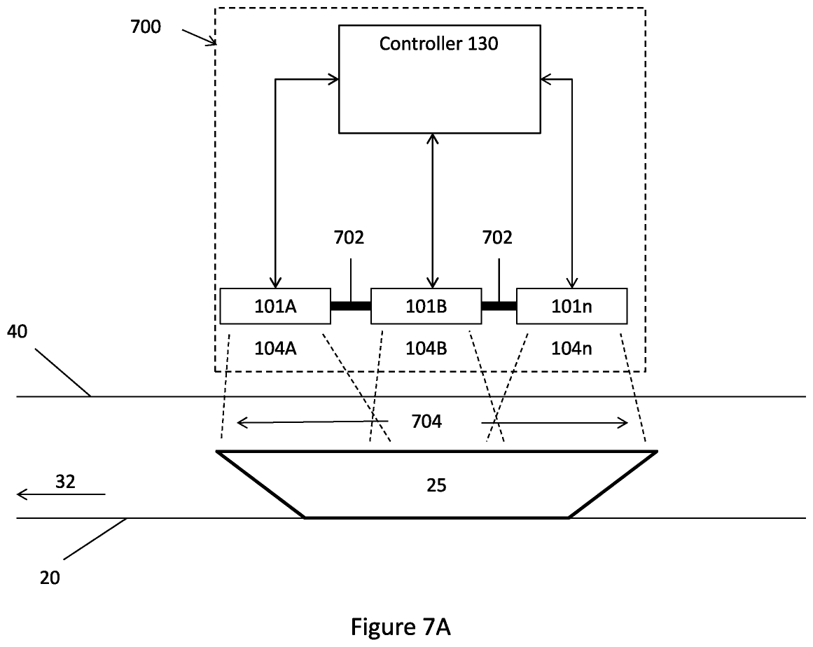

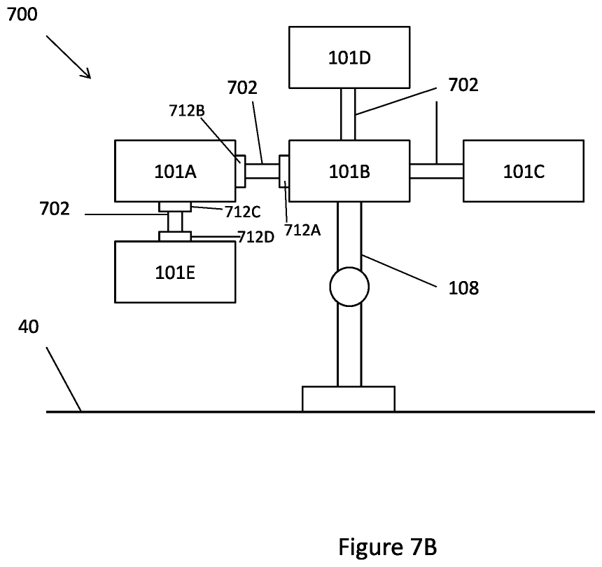

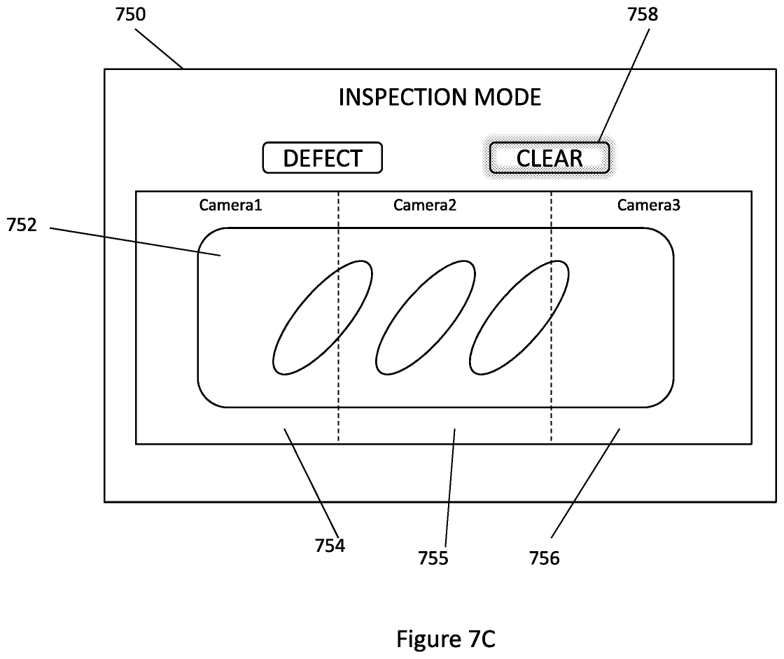

Reference is now made to FIGS. 7A-7C which are illustrative schematic drawings showing a multi-camera automated visual inspection appliance on a production line and a related illustrative screenshot according to at least some embodiments of the present disclosure. In the embodiment of FIGS. 7A-7B, multiple camera assemblies 101A-101n are controlled by a single controller 130 and camera assemblies 101 are positioned where the respective fields of view 104A-104n capture overlapping aspects or adjoining aspects of item 25.

As shown in FIGS. 7A and 7B, VIA 700 comprises a single mounting arm supporting multiple camera assemblies 101. In FIG. 7A three camera assemblies 101A, 101B, and 101n are shown for simultaneously imaging overlapping or adjoining aspects of item 25 such that controller 130 can combine the images provided from FOVs 104A, 104B, and 104n of each inspection assembly into a single FOV 704 to provide a single inspection result for item 25. Camera assemblies 101A, 101B, and 101n are joined together by connector arms 702.

In a further example of FIG. 7B, VIA 700 comprises a single mounting arm 108 supporting five camera assemblies (101A-101E) which are joined using connector arms 702. It should be appreciated that any reasonable number of camera assemblies 101 can be mounted in such a VIA 700 based on the weight of the camera assemblies 101 and the stability of the VIA 700.

Optionally connector arms 702 comprise sensors 712 that can detect the relative positions and angles of attached camera assemblies 101 for providing the detected positions and angles to controller 130 to guide controller 130 to automatically combine the images provided from the FOVs 104 of each camera assembly.

In the non-limiting example of FIG. 7B, sensors 712A and 712B detect that camera assemblies 101B and 101A are positioned at the same height but are spaced horizontally apart. Sensors 712A and 712B are further adapted to detect the relative angles of mounting and the distance between camera assemblies 101B and 101A. Further, camera assembly 101A is mounted to the right (as viewed from above) of camera assembly 101B. This relative positioning data provided to controller 130 by sensors 712A and 712B guides controller 130 to position the captured images from camera assemblies 101B and 101A side by side, where the image from camera assembly 101A is to the right of the image from camera assembly 101B. The images are further adjusted based on the distance and relative angle of mounting. Captured images are either stitched together or shown separately.

Similarly, sensors 712C and 712D detect that camera assemblies 101A and 101E are positioned at different heights (where assembly 101E is lower than 101A) but are positioned in the same vertical plane. Sensors 712C and 712D are further adapted to detect the relative angles of mounting and the distance between camera assemblies 101A and 101E. This relative positioning data provided to controller 130 by sensors 71CA and 712D guides controller 130 to position the captured images from camera assemblies 101A and 101E one above the other, where the image from camera assembly 101A is above the image from camera assembly 101E. The images are further adjusted based on the distance and relative angle of mounting. Captured images are either stitched together or shown separately.

FIG. 7C shows an illustrative screenshot 750 from UI 132 of controller 130 for the embodiment of FIGS. 7A-7B. As shown, the three captured views 754, 755 and 756 respectively of camera assemblies 101A, 101B and 101n are seamlessly joined (“stitched”) together to present a single view 752 of item 25. The stitching process may include adjusting the camera and lighting settings for each received image such as but not limited to zoom so as to match up the received images. The screenshot of FIG. 7C illustrates inspection mode for item 25 where indicator 758 shows that the item inspected is clear of defects.

Reference is now made to FIGS. 8A and 8B showing respectively a movement graph and images captured by a camera assembly and a flow diagram illustrating choice of an optimal image according to at least some embodiments of the present disclosure.

As above, VIA 100 is mounted on surface 40 which forms part of the production environment. Surface 40 might therefore impart movement or vibrations from the production surfaces to mounting assembly 108 which may in turn cause camera assembly 101 to vibrate, potentially disrupting image capture. Process 850 illustrates a mechanism to mitigate these vibrations by determining the instance of least movement using accelerometer 109 of camera assembly 101.

In step 851 of process 850 during the inspection process when item 30 is stopped for inspection by VIA 100, multiple image frames “A-I” are captured by camera 102 of item 30. Concurrently, accelerometer 109 measures movement amplitude over time as shown in illustrative graph 800. Both images and data from accelerometer 109 are fed to controller 130.

In step 852 controller 130 determines the instance of lowest movement, here illustrated as point 802 on graph 800. In step 853 controller 130 selects the captured image at the determined point in time 802, here shown as corresponding to image “F”. The selected image is assumed to have the least vibration-induced distortion of the captured images. In step 854, controller 130 runs an inspection algorithm on the selected image for defect detection, gating, sorting or counting.

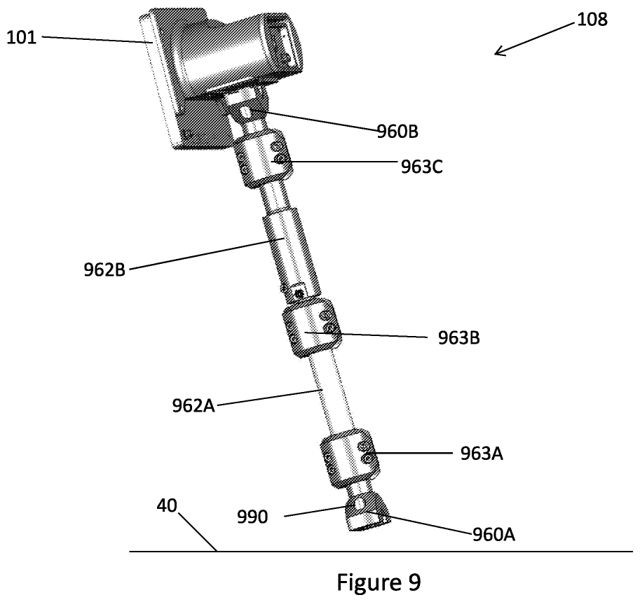

Reference is now made to FIG. 9 showing a mounting assembly and camera assembly of an automated visual inspection appliance according to at least some embodiments of the present disclosure. FIG. 9 shows an alternative embodiment of mounting assembly 108. As shown in FIG. 9, mounting assembly 108 preferably comprises multiple adjustable parts, varying in size and varying in their capacity for adjustment, that enable the positioning of camera assembly 101 into any required position. In the embodiment of FIG. 9, mounting assembly 108 comprises segments 962A and 962B, and mounts 960A and 960B. These are joined together by joints 963 (A-C). While FIG. 9 shows two segments 962 this arrangement should not be considered limiting and in practice, mounting assembly 108 can comprise more or less segments 962 as are required to position camera assembly 101 in its optimal position.

Mount 960A enables attachment of mounting assembly 108 to mounting surface 40. Mount 960A preferably comprises mounting holes 990 through which bolts (not shown) or other fixation means such as clamps, nuts, sliding blocks, springs, connectors, and/or brackets can be threaded for attachment to surface 40. Alternatively where mounting surface 40 comprises aluminum profiles, such as but not limited to those manufactured by Bosch Rexroth®, mount 960A is adapted to attach to these profiles and comprises attachment means including but not limited to clamps, bolts, nuts, t-nuts sliding blocks, springs, connectors, and brackets such as but not limited to those manufactured by Bosch Rexroth®. Optionally any attachment means known in the art can be used to fix mount 960 to surface 40. Optionally mount 960A is adapted for mounting to any form of mounting surface 40 including but not limited to a circular or elliptical pipe. Mounting holes 990 are preferably oblong rectangular or oval holes enabling flexibility of positioning of mount 960A before fixing of mount 960A with attachment means to surface 40. Mount 960A is adapted for connection to a joint 963 (e.g., joint 963A) for connection of mount 960A to segment 962A or other segments. A joint 963 is a connector for connecting and/or changing the plane of connection between parts of mounting assembly 108. As used herein the term “segment” also includes joint segments.

Mount 960B enables attachment of mounting assembly 108 to camera assembly 101. Optionally any attachment means known in the art can be used to fix mount 960B to camera assembly 101. Mount 960B is adapted for connection to joint 963 for connection to segments 962 or mount 960A.

Segments 962 are adapted for connection to joints 963. Segment connections in assembly 108 are preferably provided in at least two planes to enable adjustment of mount assembly 108 in any direction.

Segments 962 are optionally of variable length such as segment 962B. Segments 962, mounts 960, and joints 963 are all collectively referred to herein as the parts or components of mounting assembly 108.

In one embodiment a kit may be provided, which includes an assembly of components that enable ease of use and , when assembled, provide a flexible mount for positioning a camera for automated visual inspection of an item on an inspection line. In one embodiment the kit includes a mount configured to allow flexibility of positioning of the mount on a mounting surface of the inspection line; a varying length segment configured to connect between the mount and the camera and a connector configured to connect two component of the kit and configured to change an angle of connection between the components. The kit further includes instructions to input measurements of a position of an item to be inspected relative to a mounting point of the mount. The instructions may be written or otherwise displayed on a paper and/or via a user interface device.

It should be appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination.

1-23. (canceled)

24. A mounting assembly for a camera on an inspection line, the assembly comprising:
a segment configured to connect between a mount and the camera; and
a connector configured to connect between the segment and the mount and configured to enable a change of an angle of connection between the segment and the mount, the connector comprising
angle markings,
an angle pointer, and
a fixing mechanism to fix the segment at a connection angle with the mount, at which the angle pointer is in alignment with a desired angle marking, thereby enabling positioning of the camera assembly at a required position.

25. The mounting assembly of claim 1 wherein the segment comprises length markings for exact adjustment of the segment length to a desired length.

26. The mounting assembly of claim 24 wherein the mount is configured to be fixed to an aluminum profile of the inspection line.

27. The mounting assembly of claim 26 wherein the aluminum profile comprises a pipe.

28. The mounting assembly of claim 26 wherein the mount comprises at least one hole through which a fixing mechanism fixes the mount to the aluminum profile, the hole shaped to allow flexibility of positioning of the mount on the aluminum profile.

29. The mounting assembly of claim 28 wherein the at least one hole has an oblong shape.

30. The mounting assembly of claim 28 wherein the mount comprises a plurality of holes in close proximity to each other.

31. The mounting assembly of claim 24 further comprising a motor to move or adjust a component of the assembly, the motor controlled by a controller running software to calculate an optimal position for the camera.

32. The mounting assembly of claim 31 wherein the motor is configured to adjust the segment to a desired length.

33. The mounting assembly of claim 24 further comprising a mechanical motion stabilizer configured to limit unintended movement of the camera.

34. The mounting assembly of claim 24 further comprising a light source having multiple separately controllable segments, the light source separately attachable to the assembly.

35. The mounting assembly of claim 24 further comprising a plurality of cameras and a sensor to detect relative positions of the cameras, the sensor in communication with a controller running software to provide a single image for inspection from the cameras, based on input from the sensor.
